(19) United States
(12) Patent Application Publication
(10) Pub. No.: US 2009/0132385 A1
(43) Pub. Date: May 21, 2009

(54) METHOD AND SYSTEM FOR MATCHING USER-GENERATED TEXT CONTENT

(75) Inventors: Riku Inoue, Stanford, CA (US); Wendong Zhu, Berwyn, PA (US)

Correspondence Address: Techtain Inc., 540 E. Charleston Rd., Palo Alto, CA, 94306, US

(73) Assignee: Techtain Inc., Palo Alto, CA (US)

(21) Appl. No.: 12/273,558

(22) Filed: Nov. 19, 2008

Related U.S. Application Data
(60) Provisional application No. 60/989,804, filed on Nov. 21, 2007.

(51) Int. Cl. G06Q 30/00

(52) U.S. Cl. 705/26

(57) ABSTRACT

According to a computer implemented method and system for matching user-generated text content, users “freely” specify content by means of fed-in texts which are matched automatically, according to rules in the embodiment. An embodiment of the invention allows customers to specify what items or services to request or offer by adding, to the “MyHaves” or “MyWants” selection criteria, using typed-in descriptions. Traditionally, for the purpose of matching supplies and demands, the specification of an individual's “wants” and “haves” is done by selecting options that are predefined by, or hard-coded into, the system's “drop-down menu”—rather than allowing customers to freely define what they want or have. This method under consideration, however, provides an efficacious solution: customers are free to request an item or service by entering standard descriptive texts describing what s/he wants in a customizable manner very akin to the flexibility associated with verbal speech, with the assurance that these human-entered texts will be matched automatically. Similarly, a customer is free to offer an item or service in the aforementioned (text-descriptive) way. The entered texts are in the form of a specific human language (e.g. English, Chinese, etcetera) using the desired input device, such as a computer keyboard. The system algorithm of an implementation then “crawls” through the network of user generated texts (user-defined texts) to find matches between what people are offering and what others are requesting, while watching out for typographical errors (in the text content) made by customers. That is to say, the algorithm in the embodiment scours the texts in the “MyWants” section of requesters and sees if there are corresponding matches found in the “MyHaves” section of offerers, while paying attention to certain system rules.

Although the invention essentially lies in the ability to match raw user-generated texts—that fall out of system-provided categories—to achieve any desired purpose of an embodiment, the invention has applicability in sundry areas where utility may be derived. In an embodiment of the invention, for example, when a match is found, the system automatically triggers an email that is sent to the offerer, notifying him/her that a fellow customer wants what the offerer-customer has to offer. If the offerer-customer agrees to deliver the item or service to the requester, the implementation proceeds to require the requester customer to confirm receipt once the item is received. The utility here is the expeditious re-allocation of resources whose descriptions fall outside the predefined categories of the system and, consequently, may only be accurately provided by the persons wanting or offering the resources (items or services).

### FIELD OF THE INVENTION

The present invention claims—in a non-provisional context—the benefits and priority of a prior provisional application (Application #60989804) that relates to techniques for analyzing relevance of user-generated text contents. More particularly, it relates to methods for finding and automatically matching pairs of closely related user-generated text items/services from databases.

### BACKGROUND OF THE INVENTION

Conventional resource re-allocation models on the internet are premised on either (i) pre-categorized (system-defined) lists to which users are bound to associate their (and others') valuables for the purpose of specifying wanted or offered goods and services, or (ii) long and multiple pages, of cluttered and uncategorized items/services, through which customers must scroll or browse tediously before finding—amidst the clutters—the items or services they want or wish to offer. Clearly, these models suffer inefficiencies amongst which are inaccuracies caused by algorithmic neglect, customer frustration, time wastage, and hence sub-optimal resource re-allocation.

Firstly, consider websites that provide the service of matching items to customers who need those items. On such websites, a customer describes the item/service desired by selecting—from a list of options on the website. The system then searches for the item. However, the customer can only select from a “drop-down menu” of pre-defined item options or broad categories provided by the website. Such a customer can seldom instruct the system to fetch an item that is outside the pre-defined scope. These pre-defined categories of conventional solutions often relate to books and media products such as DVDs, CDs, and electronic devices which have unique identification numbers (IDs) such as bar codes, SGTINs (Serialized Global Trade Item Numbers), product numbers, and ISBNs (International Standard Book Number). Yet, there are many goods that are not media products, and many services which seldom, or never, have unique IDs. Therefore, it is necessary to provide an effective way to match goods and services which often fall outside generic classifications but can be precisely described using descriptive text methods. Examples of these goods include furniture, clothing, bedding, footwear, etcetera, and examples of these services include tutors, dentists, tailors, plumbers, etcetera.

Secondly, the corollary of the inability of current solutions to match user-generated texts is the pressure put on customers to expend precious time manually looking through the system in search of items or services they want. As such, customers—who seek items/services that conventional models cannot handle—are left with the option of scrolling through pages and browsing multiple pages in the bid to find a single item amidst the categorized or uncategorized clutters in the system. Many times, after several minutes or hours of manually scouring the platform, customers end up not finding what they had set out to obtain, either because the item/service is not available or because it is available but cannot be located—or both. Too often, the real monetary value of the time spent looking for certain kinds of items far exceeds the value of the item itself, causing users of the service to feel emotionally dissatisfied. Needless to say, there is a pressing need to use available technology to empower customers to save more time not spend more time.

Another dilemma posed by current re-allocation solutions is yet related to the perceived pressure on the customer. Because conventional and prior systems only handle pre-defined categories while also providing a search tool, customers (looking for items and services outside the pre-defined categories) resort to using the search tool. Unfortunately, however, the inability to handle user-generated text descriptions makes even this option ineffectual. Take, for example, a customer looking for a “professional plumber around Manhattan”. The service sought is not just a plumbing service; again, it is not just a professional plumbing service; it is also not just any service in Manhattan. As such, categorizing such service is rather impossible. Since conventional and prior solutions fail to handle such out-of-scope description, the customer is left with the option of entering “professional plumber around Manhattan” into the search field/tool. Sadly, the results shown will often include separate descriptions related to “professional”, descriptions related to “plumber”, and descriptions related to “Manhattan”. Simply put, the results may separately include the following: “professional driver”, “job seeking plumber”, “Manhattan firms”, “Manhattan professionals” and—sometimes, luckily, amidst the thousands of irrelevant results and multitude of pages—the desired result, “professional plumber around Manhattan”. Nevertheless, because of frustration, impatience, and the imperfect nature of the human eyes, customers may never realize that their intended search result was matched to their query, if in fact it was indeed matched. This, again, is another shortcoming caused by an inability to match user-generated (user-defined) text content.

Categorization of content has been conventionally used to handle structure and matching, and this has been the case because it is a relatively simplistic way to achieve desired results to some rather considerable extent but, in practical as in theoretical science, no category can define a thing as well as the words that describe the thing itself; no two different words mean exactly the same thing. On the one hand, most things are best described in written or typed words, and it is impossible to categorize everything thinkable or everything wanted/offered. On the other hand, recent technology, such as an embodiment of the invention, makes it possible to intelligently match items based upon certain rules or frequency and relevance, hence offering unprecedented levels of descriptive granularity requisite to efficient resource re-allocation. Just as humans become more comfortable with words and phrases as they come across those word combinations more frequently, an implementation of the invention can determine relevance and come close to mimicking a human approach to recognizing content, simply by dynamically analyzing how frequently each textual content (word or term) occurs in the system.

Given the shortcomings of prior and conventional models of resource re-allocation, and the limitless yet subtle vagaries associated with what customers seek, there is an urgent need for accurate recognition and correct matching of content—a method and system for matching user-generated text content.

### SUMMARY OF THE INVENTION

An embodiment of the present invention provides a scalable method and system for matching user-generated text content. Such user-generated (user-defined) text may exist in a database which powers a grocery store inventory list, the content of website, etcetera. As there are numerous goods, services, items, and resources that lack unique IDs—and therefore cannot be categorized into pre-defined menus—the present invention provides a means to conveniently and effectually match such out-of-scope text content according to algorithmic rules governing a desired purpose. The present invention describes a method and system that automatically measures the relevance of user-generated text content, finds pairs of closely related user-generated text content in a database, and computes the relevance measure of two user-generated text items in a way that is easily scalable to large databases.

In handling the described task, the system starts by preprocessing user-generated text contents. In this process of preprocessing, terms in the text item are stemmed into simpler forms so that “same” terms with different forms, such as different time-tense (present tense, past tense “ed”, past participle tense “en”) are recognized as rather identical. Also, stop-words, such as “a” and “the”, which are so common that they do not indicate any attribute of items, are eliminated. After the preprocessing, all terms in the preprocessed item are counted. Those counts are stored in a table in which tuples of the term itself and its count reside. Here, a tuple is a row in the database table which represents one term. Subsequently, the terms in the count table are mapped to the terms in a dictionary created from a large corpus. (The present invention does not rely on a specific type of corpus, but web pages on the World Wide Web or the whole database of the user-generated text contents are good candidates for the corpus. The dictionary is a table whose fields contain a unique identification number for each term, the term itself, a term frequency, and other auxiliary data such as inverse document frequency). The user-generated text item is then converted into term frequency vectors, which consist of series of integer valued counts of terms, to compactly and efficiently represent it (the text item). Each user-generated text is converted to a term frequency vector which consists of collections of pairs of “term IDs” and “count of the terms in the text.” The term frequency vectors are sparsely encoded to enhance computation and storage. During sparse encoding, only terms that appear in the “text item” are encoded in the frequency vector. The term frequency vector is then stored in a database that is linked to the “text item” itself. After this, on request, pairs of closely related text items are computed using the term frequency vector computed and stored in the above process. A matching request can be described in plain-English as “find matched items for a target item.” At the beginning of this process, items that contain at least one term which occurs in the target item are selected from the myriad of items in the database. After the pre-filtering, matching scores are computed for all pairs of the target item and each item in the pre-filtered item set. The computation of the matching score is derived from the cosine similarity of two term frequency vectors. Here, inverse document frequency is also used to weight different terms' contribution to the score. The score is used to select the top-k highly scored items as matched items—where parameter k is an arbitrarily selected integer number which represents the desired number of matched items the system shows to users by design. The end result is a list of user-generated items which are closely related to the target item.

### BRIEF DESCRIPTION OF THE DRAWINGS

Embodiments of the present invention are illustrated and represented by way of hypothetical examples, and not by limitation, in the accompanying illustrations and in which like numerical and alphabetical references refer to like elements, and in which:

FIG. 1 is a diagram depicting a chronological overview of the matching process in an embodiment of the present invention.

FIG. 2 is a flow chart illustrating the process of creating term frequency vectors which are representative of user-generated text contents in an embodiment of the present invention.

FIG. 3 is a flow chart illustrating the progression—and result—of the matching algorithm that analyzes similarities among multiple user-generated text items/services in an embodiment of the present invention.

FIG. 4 is a flowchart illustrating an instance of a request (by user-generated text) to which an offer is (not) matched in an embodiment of the present invention.

FIG. 5 is a flowchart illustrating an instance of an offer (by user-generated text) to which a request is (not) matched in an embodiment of the present invention.

### DETAILED DESCRIPTION OF THE INVENTION

Detailed description herein of the present invention is expressed in stepwise fashion describing the invention holistically.

The present invention provides a method and system for matching user-generated text content in a database. It is necessary for the detailed description herein to be preceded by a brief definition of terms. As used herein, the term “user-generated” is synonymous with “user-defined”, both of which describe information or data content freely supplied by a user by means of an input device; in this case, a computer keyboard. As used herein, the term “pre-defined” describes the quality that makes certain types content unalterable because they are provided as options by the system rather than by the user. Herein, the term “hard-coded” often means the same thing as “predefined”. As used herein, the term “drop-down menu” refers to a system-provided list of predefined options from which a user must select in order to proceed to the next interface. As used herein, “term ID” is the uniquely allocated integer value which distinguishes terms that appear in text items while, as expected, the “count of a term” or equivalently “term frequency” is the number of times a specific term appears in a text item. As used herein, a “term frequency vector” is a d dimensional vector consisting of a series of integers, where d is the total number of distinct types of terms in the dictionary. The index of the vector value is the term ID, and each value in the vector represents the count of a term in a specific text item. As used herein, “text item(s)” indicates the same concept as “item(s)”, but the expression emphasizes a text data property of item(s). As used herein, the terms “resource(s)”, “item(s)”, “good(s)” and “service(s)” are all used interchangeably for the sake of clarity. They refer to anything a customer wishes to part with, dispose of, provide, sell, own, request, or purchase. Examples of these are new or used textbooks, clothing of any kind, electronic devices, music or video stored on non-volatile memory such as tape, optical medium, magnetic medium, etcetera. More interesting examples include services such as tutorials, plumbing, repairs, catering, event planning, and the like. In essence, anything the customer so desires to offer or request, and that can be typed into the system will qualify for a resource, item, good, or service. In a embodiment of the invention applied to resource re-allocation, the customer is not limited in any way at all because the decision of what to request or offer is totally left to the customer's willingness to supply such information to the system.

In the following description, the term “user” refers to the person actively using the system while the term “customer” refers to the person who may or may not be currently using the system. Hence, all users are customers but not all customers are users; better yet, a user is an active instance of “customer” status while a customer could be an active or idle instance of “customer” status.

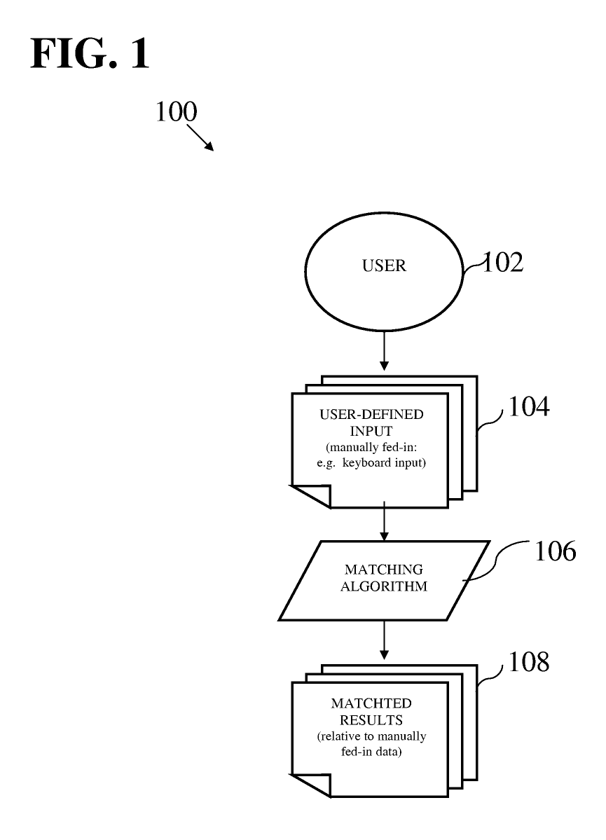

FIG. 1 is a diagram 100 depicting a chronological overview of the matching process in an embodiment of the present invention. User 102 is either requesting or offering a good or service by typing in the user-generated description 104 of the item. The matching algorithm 106 is automatically invoked upon the generation of text content 104. The matching algorithm 106 takes the user-generated item 104 as input, and generates the matched results 108. In this process, all items in the database—except the item 104—are individually evaluated to check whether there is a match between each database item and the user-generated item 104. First, the database items are pre-filtered so that those that do not contain at least one term which occur in the item 104 are eliminated. After the pre-filtering, matching scores are computed for all pairs of the item 104 and each item in the pre-filtered item set. The matching score is computed by deriving the cosine similarity of two term frequency vectors. The efficiency of the matching algorithm can be described as O(nm) given the total number, n of items in the database and the average number, m of distinct types of terms in an item. The score is used to select the top-k highly scored items as matched items. The end result is a list of user-generated items which are closely related to the target item.

In representation 100, the user-generated text content provided by user 102 could serve one of two main purposes—or both. Firstly, it could function as a request-agent in which case user 102 is requesting an item by inputting a user-generated request 104, and user 102 is called a “requester.” In this case, the matching algorithm 106 is run for “offer” item database to create a list of matched offer items 108. Secondly, it could function as an offer-agent in which case user 102 is offering an item by inputting a user-generated offer 104, and user 102 is called an “offerer.” In this case, matching algorithm 106 is run for “request” item database to create a list of matched request items 108.

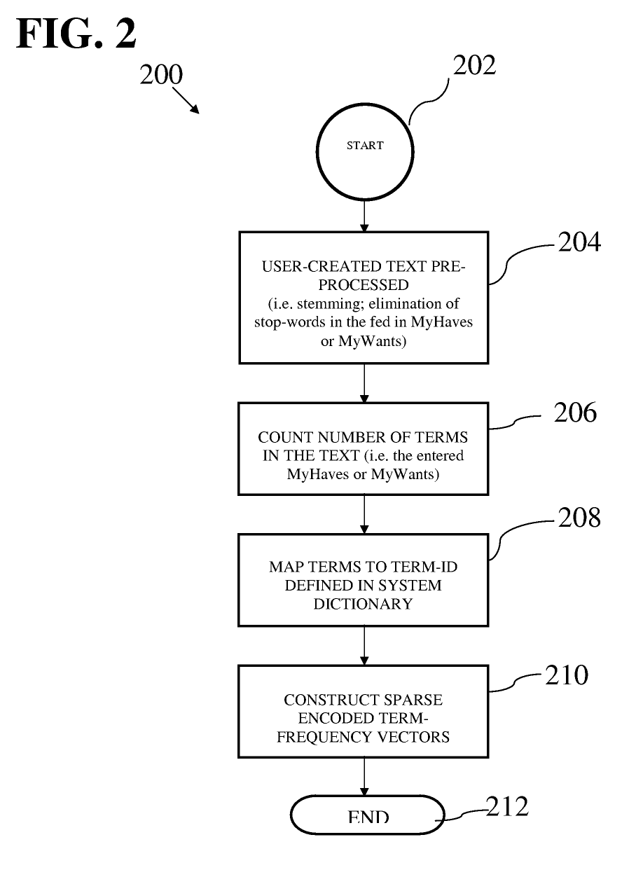

As explained, a user generated descriptive text content 104 could describe an item or service being offered (i.e. in the “MyHaves” section of an embodiment) or requested (i.e. in the “MyWants” section of an embodiment), but for the process of matching to begin, term frequency vectors which represent user-generated text contents must be created as depicted in FIG. 2, a diagram 200 which is a flow chart illustrating the process of creating term frequency vectors which are representative of user-generated text contents in an embodiment of the present invention. The term frequency vector creation process depicted in the diagram 200 is invoked on creation of user-defined input 104. The creation of term frequency vectors starts at 202 just after the user creates user-defined input 104. This user-define input is then relayed to the preprocessing stage 204 where terms in the user-defined input 104 are stemmed into their components parts (stems or roots, as the case may be) so that same terms with the same stem or root but with different inflections are recognized as identical. Specifically, various inflected forms are reduced to stems by stripping the suffix. This process is done by applying pre-defined rules for the suffix stripping. For instance, if the word ends in ‘ed’, the ‘ed’ is removed. Also, exceptions such as past tense ‘ran’ (of provided ‘run’) are resolved by rules that handle those exceptional cases. Further, in the pre-filtering process 204, stop-words such as “a”, “an” and “the”—which are so common that they do not indicate any attribute of items—are eliminated.

After the preprocessing process 204, all terms in the preprocessed item are counted in step 206 after which they are mapped in 208 to term-IDs in the system dictionary—a table whose fields contains unique identification number for each term, term itself, term frequency, and other auxiliary data such as inverse document frequency. The counting is done by using a hash table whose key is the term string, so that the order of counting is O(L) given the average number of tokens in a text item L. Those counts are stored in a table in which tuples of a term itself and its count reside. The terms in the count table are mapped, in process in 208, to the terms in a dictionary created from a large corpus. The present invention does not rely on specific type of corpus; rather, web pages on the World Wide Web or the whole database of constantly increasing user-generated text contents are good candidates for the corpus. After mapping the terms in the count table to the terms in the chosen system dictionary, each user-generated text item undergoes a conversion 210 such that it is converted into a term frequency vector to compactly and efficiently represent it (the text). That is to say each user-generated text is converted to a term frequency vector that consists of collections of pairs of “term IDs” and “count of the terms in the text.” Since term IDs and count of all terms in the user-generated item are already determined as explained above, the process here involves just concatenating those determined sets of information. The term frequency vectors are sparsely encoded to enhance computation and storage. During sparse encoding 210, only terms that appear in the “text item” are encoded in the frequency vector. At the end, the resulting term frequency vector for each text item is used in two ways. Firstly, the newly created term frequency vector is used to compute matching items in the item database. Secondly, it is stored in a database that is linked to the “text item” itself for future use. The stored term frequency vector becomes a candidate for future matching processes.

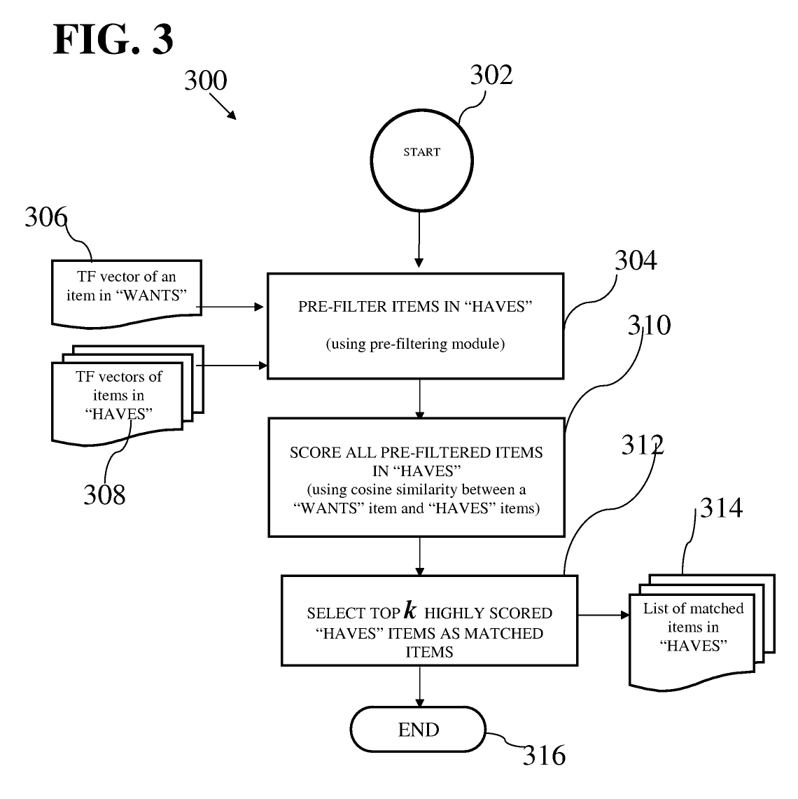

FIG. 3 illustrates the details of the matching algorithm 106, in which matching “HAVES” items are computed against a newly created “WANTS” item. The matching algorithm is automatically invoked upon the generation of text content 104, and starts from 302 as indicated in the flowchart 300. The matching algorithm takes two inputs, namely, the term frequency vector 306 that is generated from the user-generated “WANTS” item 104 in the process 200, and term frequency vectors 308 of all “HAVES” items which reside in the “HAVES” database table. Given inputs 306 and 308, the term-frequency vectors 308 of “HAVES” items are pre-filtered in the process 304 so that items that do not contain at least one term which occurs in 306 are eliminated. This pre-filtering largely reduces computational cost for calculating matching scores of unnecessary text items in the process 310. Since the matching score is measured based on co-occurrence of terms in two items, a matching score for two items that do not have any common term should be zero, and it is of no use to compute the matching score for such a pair of items. In the process 304, in order to efficiently execute the pre-filtering task, an inverse index of terms is used. Inverse index is a data structure that is widely used in the context of text-based search engines. The inverse index consists of two types of fields, namely, “term” and “pointers.” The term field contains a hashed string of a specific term for each tuple. The pointers field contains (potentially multiple) pointers to items which contain the term. The inverse index is maintained for all user-generated “HAVES” and “WANTS” items in the database. In other words, all terms that appear in user-generated “HAVES” and “WANTS” items in the database reside in the term field in the inverse index, along with pointers to all user-generated “HAVES” and “WANTS” items that contain each term. In the pre-filtering process 304, H_{T}, a set of “HAVES” items in 308 that contain any terms contained in the “WANTS” item 306, are computed using the inverse index. Suppose terms {t₁, t₂ . . . tₘ} ∈ T constitute a set of terms contained in the “WANTS” item 306. For each tᵢ ∈ T for 1≦i≦m, we can retrieve a set of pointers to item Hᵢ which contains tᵢ by looking up the inverse index. The union of Hᵢ's is equivalent to H_{T}, a set of “HAVES” items that contain any terms contained in the “WANTS” item 306. Since the lookup of the inverse index is O(l), computing H_{T} can be done using O(m), where m is the average number of distinct terms in a “WANTS” item m.

In the next process 310, matching scores between “WANTS” item 306 and each item in the set of pre-filtered item H_{T} are computed. The computation of the matching score involves determining the cosine similarity of two term frequency vectors. Let v₀ and vⱼ denote the term frequency vectors of “WANTS” item 306 and a hypothetical jₜₕ item in the set H_{T}, respectively. v₀ and vⱼ are both d dimensional vectors, where d is the total number of distinctive terms in the dictionary. Therefore, v₀ and vⱼ can be represented as

v₀=(c₁⁽⁰⁾, c₂⁽⁰⁾, . . . , c_{d}⁽⁰⁾)^{T}

vⱼ=(c₁^{(j)}, c₂^{(j)}, . . . , c_{d}^{(j)})^{T}

cᵢ^{(j)} represents a count of iₜₕ term in vector j. The matching score sⱼ between v₀ and vⱼ is computed like so, from the following equation:

$${s}_{j} = {v}_{0} \cdot {v}_{j} = {\sum }_{\text{?}}^{d} ( {v}_{\text{?}}^{( 0 )} * {v}_{\text{?}}^{( \text{?} )} )$$

$$\text{?} \text{indicates text missing or illegible when filed}$$

The efficiency of the matching algorithm can be described as O(nm) given the total number of items in the database n and the average number of distinct types of terms m. Note that since the process skips all terms except the ones that have an actual count in each vector, the efficiency depends on m, not d. The scores s₀ⱼ computed in the process 310 are used to select the top-k highly scored items as matched items in the process 312. The parameter k is an arbitrarily selected integer number which represents the desired number of matched items the system shows to users, by design. The end result of the process 300 is generated in step 312—a list of “HAVES” items 314, which is a collection of “HAVES” items that are closely related to the “WANTS” item 306. After the process 312 is completed, the process terminates as indicated in 316.

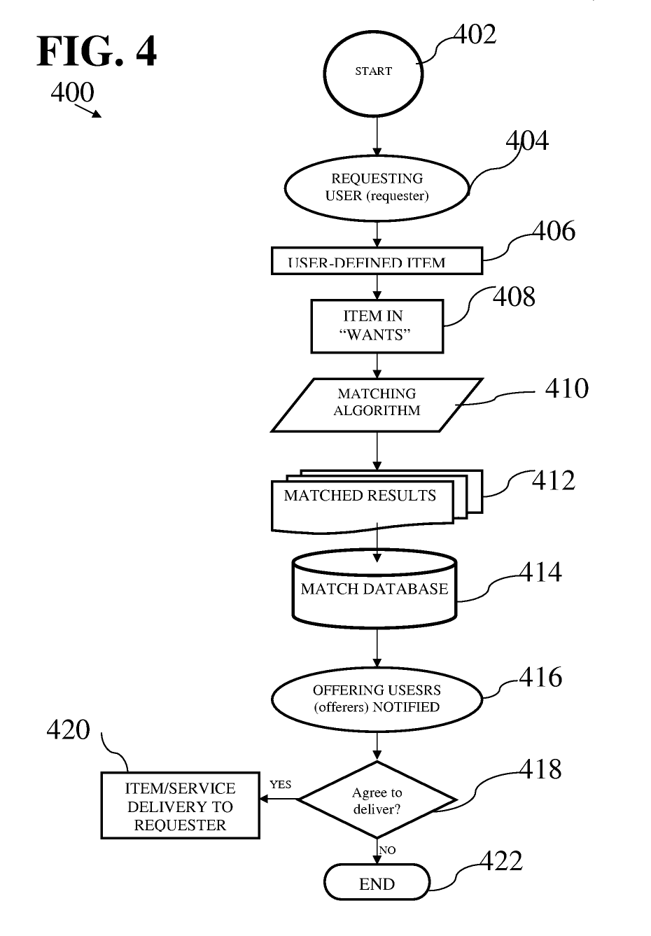

FIG. 4 is a diagram 400 illustrating an application of processes described in 100, 200 and 300. It specifically describes a case in which a requester creates a “WANTS” item, causing matching “HAVES” items to be automatically extracted from the database using the matching process described in 100, 200 and 300. The whole process is invoked by the creation of a “WANTS” item by a requesting user 404. Using an input device such as a computer keyboard, the requester first creates a text item 406 that describes what the he or she wants in text format. The created item 406 has a specific data structure as a “WANTS” item as indicated in 408. The newly created “WANTS” item is passed to the matching algorithm 410. Processes from 404 to 410 correspond, more or less, to processes from 102 to 106 in the overview 100 of the matching process. The matching algorithm 410 generates matched results 412, which consist of a list of matched “HAVES” items ordered by relevance to item 406. Matched results 412 are stored in the match database 414 for future reference. Then, in step 416 a notification is sent to the offerer who owns the “HAVES” item determined as having the highest relevance score in the matched results 412. The offerer, upon receiving the notification in any form e.g. email, can decide whether or not to agree to deliver the item to the requester 404. If the offerer chooses to deliver the item/service (described in the “HAVES” text item) to requester 404, then s/he can do so as indicated in 420. If the offerer decides otherwise, the process terminates at 422 without the actual transaction of the item or service. It is crucial to note that this aspect, of item request/delivery, just explained is only one application of an embodiment of the present invention.

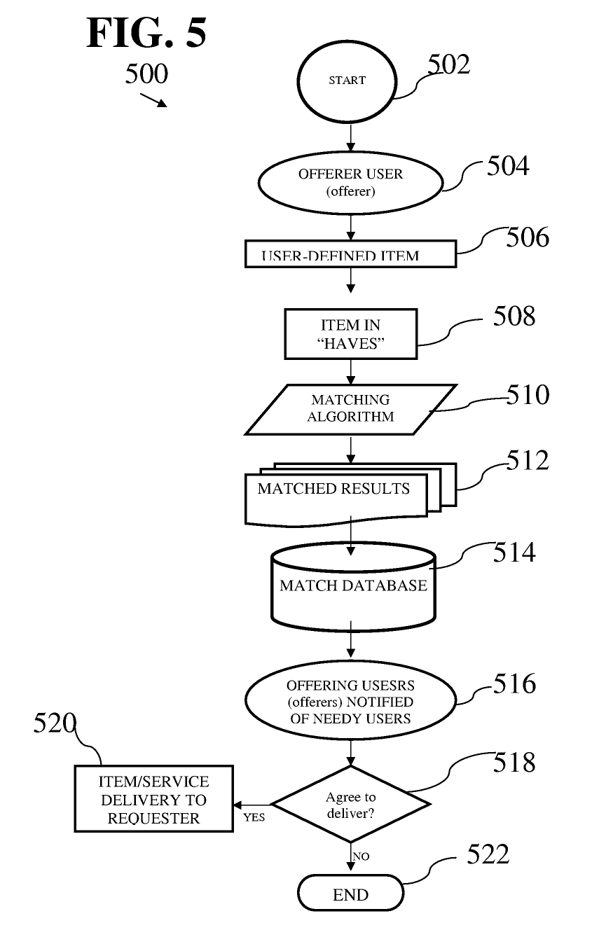

FIG. 5 is a diagram 500 illustrating another application of processes described in 100, 200 and 300. It specifically describes a case in which an offerer creates a “HAVES” item, causing matching “WANTS” items to be automatically extracted from the database using the matching process described in 100, 200 and 300. The whole process is invoked by the creation of a “HAVES” item by an offering user 504. Using an input device such as a computer keyboard, the offerer first creates text item 506 that describes what the he or she is willing to offer in text format. The created item 506 has a specific data structure as a “HAVES” item as indicated in 508. The newly created “HAVES” item is passed to the matching algorithm 510. Processes from 504 to 510 correspond, more or less, to processes from 102 to 106 in the overview 100 of the matching process. The matching algorithm 510 generates matched results 512, which consists of a list of matched “WANTS” items ordered by relevance to item 506. Matched results 512 are stored in the match database 514 for future reference. Then, in step 516, the offerer 504 is notified of “WANTS” items that have high relevance score in the matched results 512, along with the requesters' name(s)/information. The offerer 504 decides whether or not to deliver the item to a requester in the list provided in the notification 516. If the offerer 504 chooses to deliver the item/service (described in the “HAVES” text item) then s/he can do so as indicated in 520. If the offerer 504 decides otherwise, the process terminates at 522 without the actual transaction of the item. Again, this complementary functionality—to process 400—constitutes only one of the myriad of applications of an embodiment of the present invention.

The invention claimed is:

1. A computer-implemented method and system for matching user generated text content, the method comprising:
providing a less restrictive way for customers to interact with World Wide Web (WWW) and other online interfaces by freely supplying text data by means of an input device;
a more intuitive and user friendly process allowing each customer to flexibly describe the item/service desired or offered without being bound to having to select from a list of options on the website;
an efficacious means to expeditiously re-allocate resources via the recognition and matching of text content; and
thereby automatically informing a specific requester as soon as a member-customer has what the former is seeking and automatically informing a specific offerer as soon as a member-customer wants what the former is offering.

2. A method as recited in claim 1, wherein the system automatically recognizes a text content regardless of the fact that it is a non system-defined data content.

3. A method as recited in claim 1, wherein the intelligent system is able to make correct matches despite possible typographical errors made by customers.

4. A method as recited in claim 1, providing an efficient technique for analyzing accurate relative relevance of user-generated text contents.

5. A computer implemented method as recited in claim 1, wherein the system—and not the customers—does the work by implementing an autonomous “search-match-notify” algorithm.

6. A system as recited in claim 1, providing an efficient way for customers to request and obtain an item or service without requiring them to spend time searching the system manually.

7. A system as recited in claim 1, providing an efficient way for customers to request and obtain an item or service without requiring them to spend time tediously browsing through the system pages.

8. A system as recited in claim 1, providing an efficient way for customers to request and obtain an item or service without requiring them to spend time scrolling through multiple (irrelevant) pages.

9. A method as recited in claim 2, wherein the system automatically and correctly matches user-defined text content that may fall outside categories within the system.

10. A method as recited in claim 9, wherein customers conveniently specify descriptions of their desire without regard to the limits placed by the system “drop-down menu”.

11. A method as recited in claims 4 and 10, that brings the precision associated with unique IDs (SGTIN, ISBN, bar code, PID) to goods and services that, by nature, never have IDs but need to be accurately described (furniture, clothing, bedding, footwear, etcetera).

12. A method as recited in claim 4 and 11, that provides a scalable structure for cataloguing user-generated text content for a dynamic database capable of powering a retail inventory list, the content of website, etcetera.
